(19) United States
(12) Patent Application Publication
(10) Pub. No.: US 2010/0011876 A1
(43) Pub. Date: Jan. 21, 2010

(54) CONTROL SYSTEM AND METHOD TO DETECT AND MINIMIZE IMPACT OF SLUG EVENTS

(75) Inventors: Parag Vyas, Munich (DE); Emad Ahmad Obaid Gharaibah, Munchen (DE); Alvaro Jorge Mari Curbelo, Unterschleissheim (DE); Michael Bernhard Schmitz, Freising (DE); Christian Aalburg, Munich (DE)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/173,844

(22) Filed: Jul. 16, 2008

(51) Int. Cl. G01F 1/74

(52) U.S. Cl. 73/861.04

(57) ABSTRACT

A system for detecting and controlling a slug event in a flow through a pipeline is provided. The system includes multiple sensors configured to indicate one or more parameters of the flow for a slug at multiple locations in the pipeline. The system also includes a controller configured to receive one or more response signals corresponding to at least one of the parameters from the sensors. The system further includes a variable speed drive system electrically coupled to the controller and a compressor pumping fluid in the pipeline such that a ratio of liquid to gas is within an acceptable range, wherein the variable speed drive is configured to receive one or more signals from the controller and further configured to regulate at least one of a translational or a rotational speed or a power of the compressor based upon the signals. The system also includes a display unit coupled to the controller, the display unit configured to output the plurality of signals received from the controller.

### BACKGROUND

The invention relates generally to oil field operations, and more particularly, to controlling slugs in pipelines.

Pipelines are widely used in a variety of industries, allowing a large amount of material to be transported from one place to another. A variety of fluids, such as oil and/or gas, particulate, and other small solids suspended in fluids, are transported cheaply and efficiently using underground pipelines. Pipelines may be subterranean, submarine, on the surface of the earth, and even suspended above the earth. The pipelines carry enormous quantities of oil and gas products indispensable to energy-related industries, commonly under tremendous pressure and at low temperatures, and at high flow rates.

Typically, in oil fields, pipelines are used to transport multiphase mixtures such as, gas, oil, and water mixtures produced from individual oil wells to common gathering lines and to also transport the multiphase mixtures recovered from a common gathering point to a treatment facility such as a separator or like. In such a case, the multiphase mixtures frequently tend to separate during transportation to the pipeline so that there are intermittent slugs of liquid followed by slugs of gas, in a non-limiting example. The formation of such slugs in the pipelines result in severe stress on the pipelines and erratic operation of an equipment into which the pipelines discharge. Furthermore, the slugs result in flow distortions that are characterized by more or less rapid changes in pressure, temperature, density and other variables that may in turn, lead to surpassing straining limits of materials of components used for displacement of flows. Some examples of such components include blades, and impellers common to turbomachinery.

Therefore, there is a need for an improved system and method for avoiding flow instabilities caused by the slugs.

### BRIEF DESCRIPTION

In accordance with an aspect of the invention, a system for detecting and controlling a slug event in a flow through a pipeline is provided. The system includes multiple sensors configured to indicate one or more parameters of the flow for a slug at multiple locations in the pipeline. The system also includes a controller configured to receive one or more response signals corresponding to at least one of the parameters from the sensors. The system further includes a variable speed drive system electrically coupled to the controller and a compressor pumping fluid in the pipeline such that a ratio of liquid to gas is within an acceptable range, wherein the variable speed drive is configured to receive one or more signals from the controller and further configured to regulate at least one of a translational or a rotational speed or a power of the compressor based upon the signals. The system also includes a display unit coupled to the controller, the display unit configured to output the plurality of signals received from the controller.

In accordance with another aspect of the invention, a method for controlling a slug event in a flow through a pipeline is provided. The method includes sensing one or more parameters of the flow for the slug via multiple sensors disposed at a plurality of locations in the pipeline. The method also includes transmitting one or more signals corresponding to the parameters sensed to a controller. The method further includes regulating at least one of a translational or a rotational speed or power of a compressor pumping fluid into the pipeline via the controller based upon the signals and a detection of the slug in order to create an unsteady flow oscillation to affect a flow of the slug. The method also includes regulating multiple valves via the controller upon detection of the slug.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary slug flow regime in accordance with an embodiment of the invention;

FIG. 2 is a schematic illustration of an exemplary system employing an external supply for stabilizing multiphase flow in a pipeline according to an embodiment of the invention;

FIG. 3 is a schematic illustration of another exemplary system employing an external supply of fluid for stabilizing multiphase flow in a pipeline according to an embodiment of the invention;

FIG. 4 is a schematic illustration of an exemplary system employing an internal supply and a storage facility for fluid for stabilizing multiphase flow in a pipeline according to an embodiment of the invention;

FIG. 5 is a schematic illustration of an exemplary system including a pump installed at a shore for stabilizing multiphase flow in a pipeline according to an embodiment of the invention;

FIG. 6 is a schematic illustration of an exemplary system including additional valves for stabilizing multiphase flow in a pipeline according to an embodiment of the invention;

FIG. 7 is a schematic illustration of an exemplary system including an adjustable speed electronic drive for stabilizing multiphase flow in a pipeline according to an embodiment of the invention;

FIG. 8 is a schematic illustration of an exemplary system including a recirculation equipment for stabilizing multiphase flow in a pipeline according to an embodiment of the invention;

FIG. 9 is a schematic illustration of an exemplary system including a control system for a pump installed for detecting a slug event and stabilizing multiphase flow in a pipeline according to an embodiment of the invention;

FIG. 10 is a schematic illustration of an exemplary system including backward facing elements installed in the system of FIG. 8;

FIG. 11 is a flow chart representing steps in an exemplary method for stabilizing flow in a pipeline according to an embodiment of the invention; and

FIG. 12 is a flow chart representing steps in another exemplary method for stabilizing flow in a pipeline according to an embodiment of the invention.

### DETAILED DESCRIPTION

As discussed in detail below, embodiments of the invention include a system and method for eliminating slugs. As used herein the term ‘slug’ refers to multiphase mixtures including, but not limited to, oil, gas, water, and sand that flow typically in pipelines, and subsea wells in the oil and the gas industry. The flow in a slug regime may lead to instabilities leading to negative consequences for pipelines, downstream equipment and overall plant throughput. Various systems and methods for avoiding such slugs are disclosed herein. As used herein, the term ‘sensors’ refer to direct or indirect measurements. Non-limiting examples of the sensors include wire mesh sensors, pressure, temperature, density, conductivity, mass flow, ultrasound, optical waves, with continuous variable outputs, and binary specialized sensors with discrete output like presence/no presence. Further, the term ‘compressor’ refers generally to pumps, translational and rotatory organs.

In one exemplary embodiment, the pipeline is a flowline that is an element of subsea oil and gas production, collection, and shipping facility, including an offloading system, such as a buoy or platform offloading system. In another embodiment, the fluid may be transported in subsea wells or a manifold from which flowlines transport the fluid to a buoy or platform. Non-limiting examples of the flowline are metal pipes that are equipped with floatation devices located along lengths of the flowlines, to provide a suitable contour or configuration to the flowlines. In another embodiment, the pipes may include carbon fiber composite material. In yet another embodiment, the pipeline is land-based and receives production flow from a surface wellhead or other source.

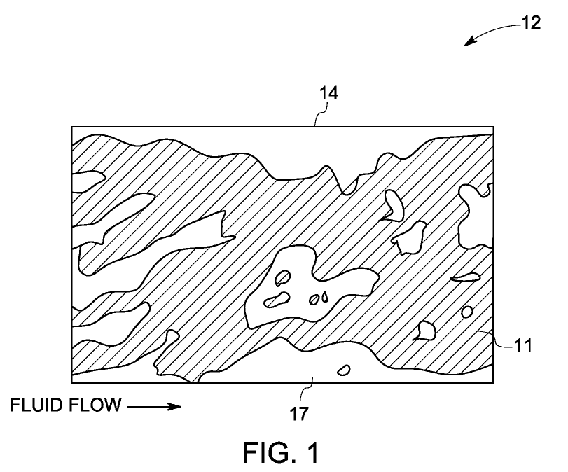

Turning to the drawings, FIG. 1 is a diagrammatic illustration of an exemplary slug flow regime 12 in an infrastructure such as, but not limited to, a pipeline 14. In the illustrated embodiment, the slug flow regime 12 includes a liquid phase 11 and a gaseous phase 17. It is desirable to minimize slug events or damage caused to the infrastructure by formation of the slug flow regime 12.

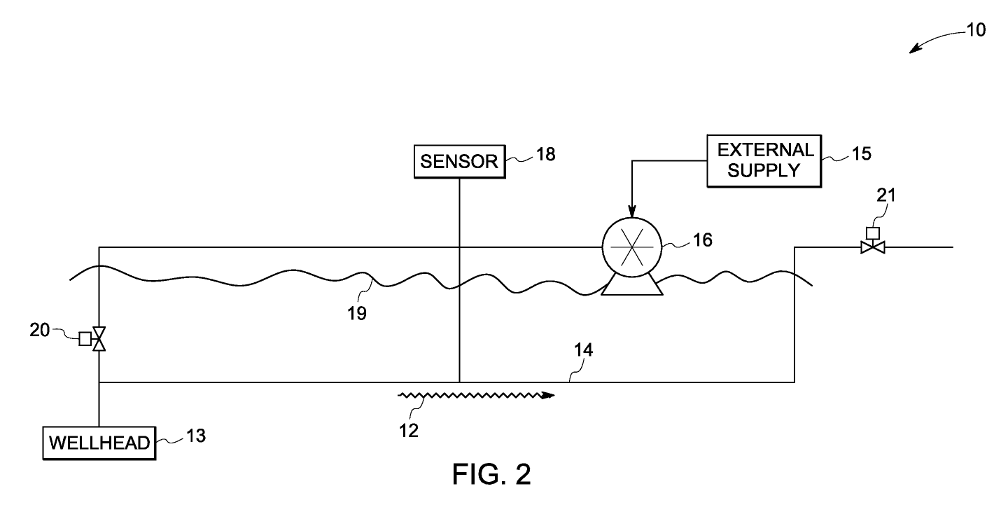

FIG. 2 is a schematic illustration of an exemplary system 10 for stabilizing fluid flow 12, as referenced in FIG. 1, in a pipeline 14. Fluid flow 12 originates from a wellhead 13. It will be appreciated that the wellhead is a non-limiting example and may include other sources of flow. The fluid flow 12 includes multiphase flows or slugs that may be unsteady and proportions of the phases may change with time. It is desirable to minimize damage caused by the slugs or slug flow. In the illustrated embodiment, the fluid flow 12 includes a two phase flow of liquid and gas. In operation, a ratio of the liquid to gas in the flow 12 is monitored and accordingly, gas or liquid supply is provided to obtain a desirable ratio that is at least above a threshold value that minimizes slug formation. An external supply 15 provides the gas or liquid supply and is coupled to the wellhead. In the presently contemplated embodiment, the external supply is a pump or compressor 16 located above the sea surface 19. At least one sensor 18 detects a ratio of liquid to gas in the flow 12. The compressor 16 operates at a set point to ensure that a ratio of liquid to gas is at least above a threshold value that minimizes slug formation in the multiphase flow 12. The set point will tend to change over time as it follows changes in the ratio of liquid to gas in the flow that is detected by the sensor 18. Valves 21 and 20 regulate motion of the flow within the pipeline to ensure elimination of the slug.

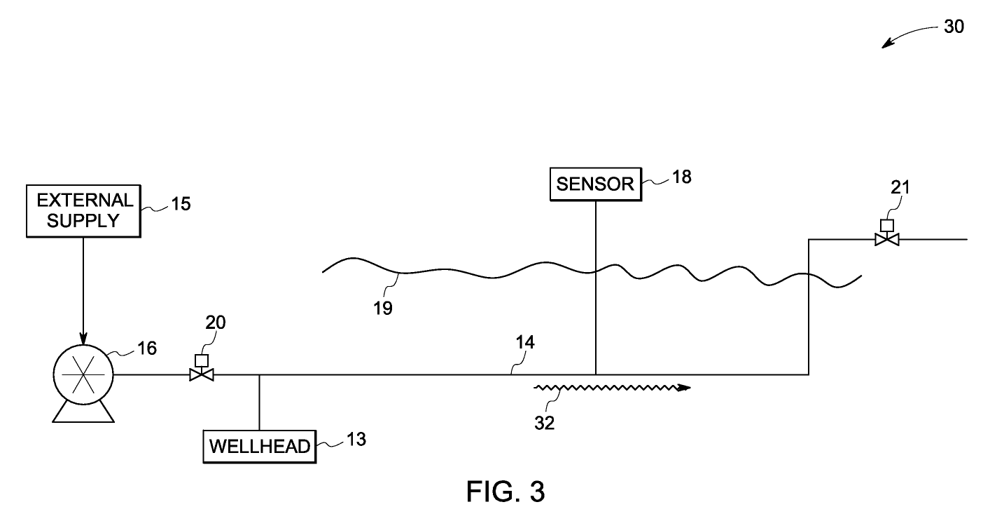

FIG. 3 is a schematic illustration of another exemplary system 30 for stabilizing multiphase flow 32 employing a pump 16 on a seabed near a wellhead 13, as referred to in FIG. 1. The system 30 includes the pump 16 (as referred to in FIG. 2) installed on or near the seabed. A large pressure exists at the source or wellhead 13 that is utilized by the pump 16 to force the fluid flow 12. Advantageously, the large pressure already existing at the wellhead is utilized by the pump and helps improve efficiency of the system 30.

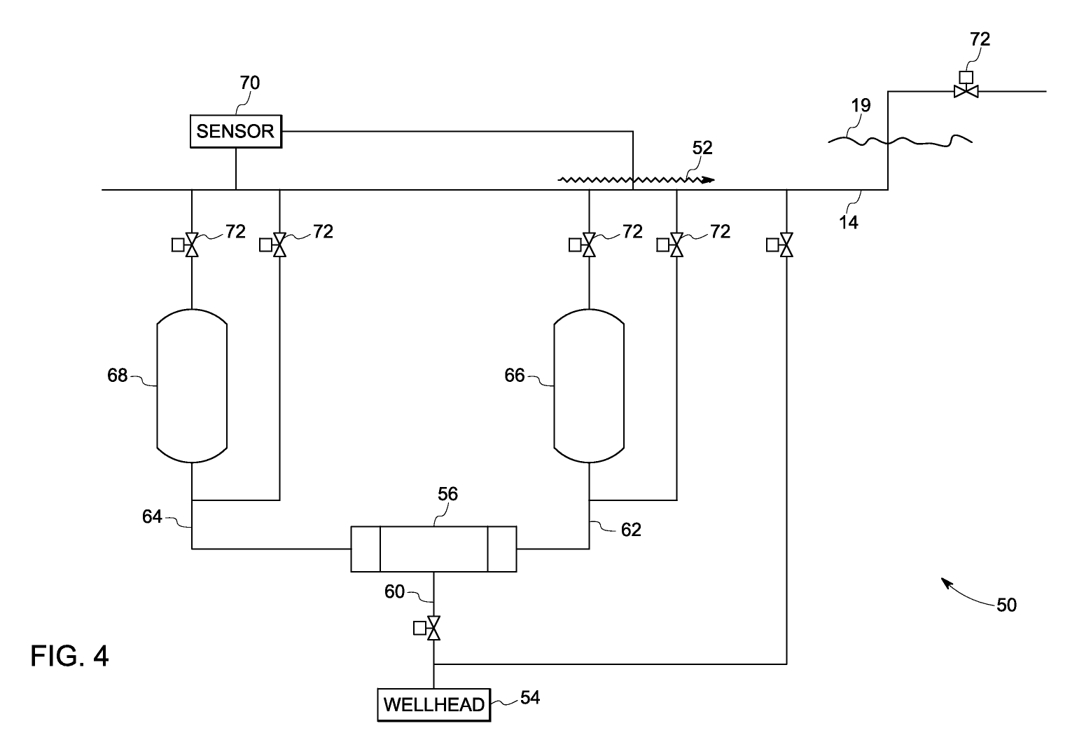

FIG. 4 is a schematic illustration of a system 50 for stabilizing multiphase flow 52 employing an internal supply of liquid and gas such as a wellhead 54. The fluid flow 52 includes multiphase flows or slugs that may be unsteady and proportions of the phases may change with time. It is desirable to minimize damage caused by the slugs or slug flow. In the illustrated embodiment, the fluid flow 52 includes a two phase flow of liquid and gas. In operation, the liquid and gas in the flow 52 is separated and stored in a storage facility. A ratio of the liquid to gas in the flow 52 is monitored and accordingly, gas or liquid is released from the storage facility to obtain a desirable ratio that is at least above a threshold value that minimizes slug formation and moves the flow outside the slug flow regime. Accordingly, a gas/liquid separator 56 is employed to isolate liquid and gaseous phases of a flow 60 that further propagates the liquid phase 62 and gaseous phase 64 into a liquid storage facility 66 and a gas storage facility 68 respectively. At least one sensor 70 is employed to detect the ratio of liquid to gas entering the multiphase flow 52. Valves 72 further regulate the flow of the liquid phases and the gaseous phases into the multiphase flow 52 such that a ratio of liquid to gas is within an acceptable range.

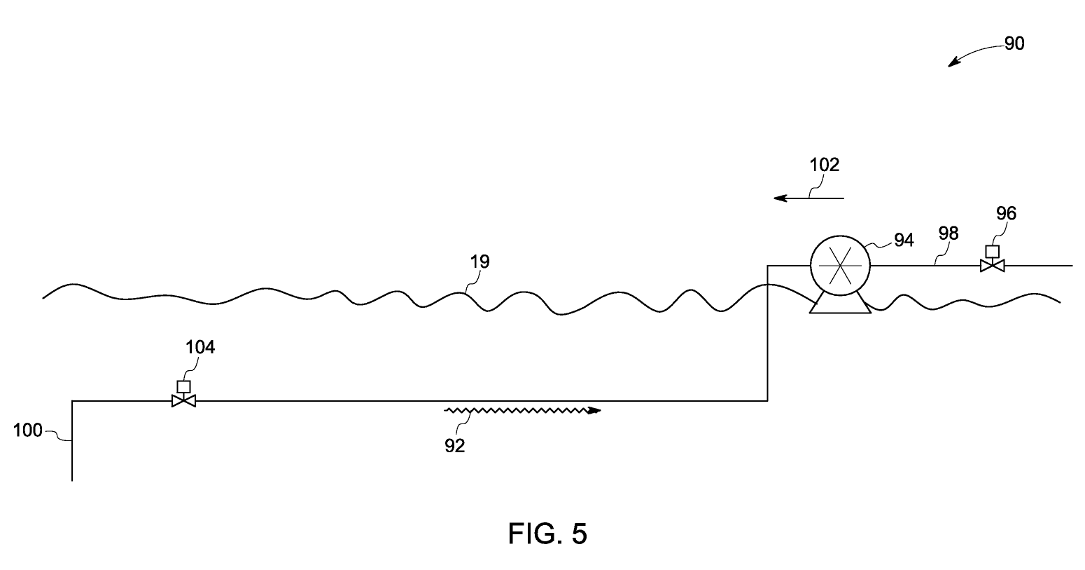

FIG. 5 is a schematic illustration of another exemplary embodiment of a system 90 controlling a multiphase flow 92. A pump 94 is installed prior to an existing valve 96 on a platform or shore 98 of a well 100. The pump 94 operates in a reverse mode such that the liquid/gas mixture is pumped in a reverse direction referenced by numeral 102. A secondary valve 104 is installed on a seabed of the well 100 to regulate a reverse flow from the pump 94.

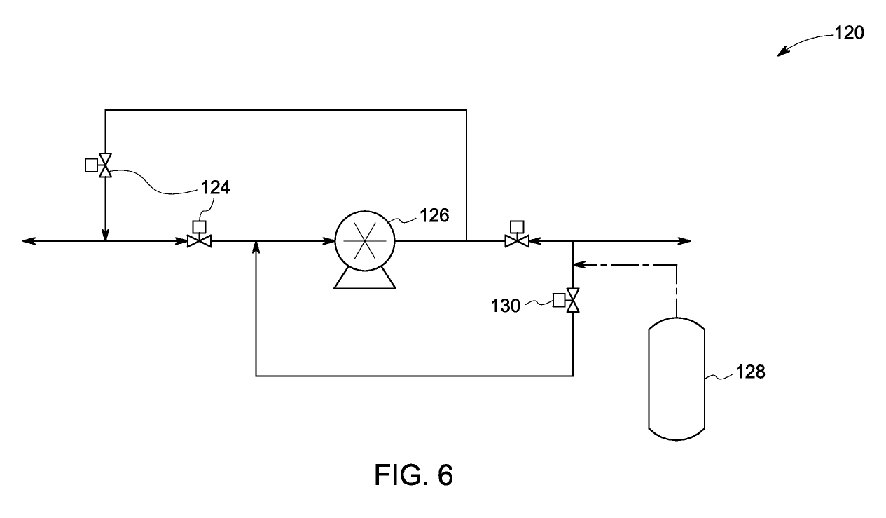

FIG. 6 is a schematic illustration of yet another exemplary embodiment of a system 120 controlling a multiphase flow employing additional valves 124. Further, a pump 126 installed at a shore delivers liquid from a storage facility 128. In a particular embodiment, the liquid is water. The liquid is pumped upstream against a wellhead or against a secondary valve 130 that is entirely or partially closed. In case of pressure of the liquid being desirably large enough such that a multiphase mixture moves out of a slug regime or a slug is destroyed, the pump 126 is returned to normal operation by closing the valve upstream and stopping injection of the liquid.

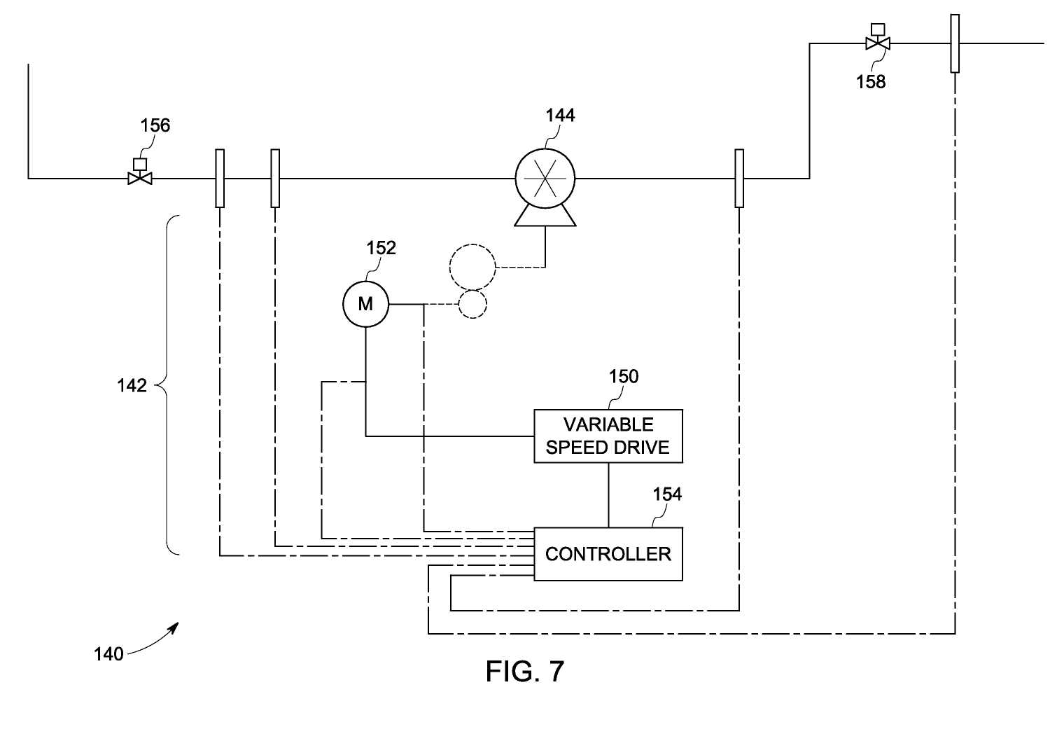

In another illustrated embodiment of the invention, a system 140 including adjustable speed electronics 142 as an antislug mechanism is depicted in FIG. 7. A pump 144 is installed at a seabed and is coupled to the adjustable speed electronics 142. In a particular embodiment, the electronics 142 includes a variable speed electronic drive 150, an electric motor 152 and a controller 154. The electronics 142 allows for flow reversal using the pump 144. In one embodiment, slug destruction is possible via closing an upstream valve 156 and operating the pump 144 in a reverse direction. In another embodiment, a downstream valve 158 is closed and the pump 144 is operated in a normal flow direction with the upstream valve 156 open.

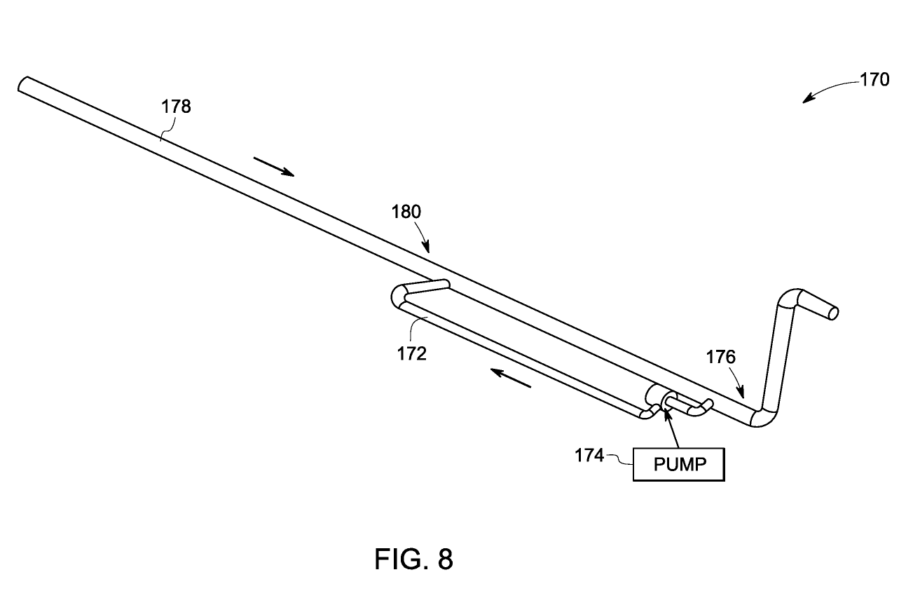

FIG. 8 is a schematic illustration of an antislug system 170 including a recirculation equipment 172. A liquid pump 174 is employed to recirculate liquid from a location 176 where slugs typically occur in a pipeline 178 to a comparably gas rich region 180 upstream of the location 176. The liquid pump 174 ensures continuous movement of a liquid phase through critical parts of the pipeline 178 preventing blockage. Slug prone locations where local recirculation is to be applied is estimated from flow parameters and a geographic signature of the pipeline 178. The recirculation equipment 172 is installed in the slug prone locations.

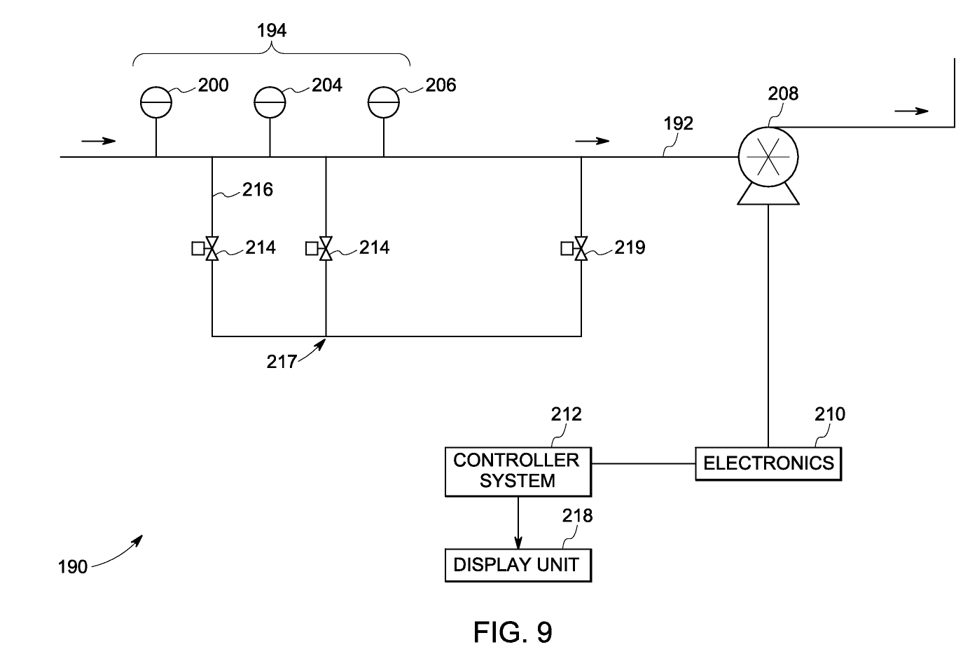

FIG. 9 is a schematic illustration of an exemplary embodiment of a system 190 that provides protection to ensure extended operation of a pipeline 192. Accordingly, multiple slug indicators 194 are installed at upstream locations to measure flow characteristics. In a presently contemplated embodiment, three sensors 200, 204, 206 are installed at the upstream locations. A non-limiting example of the sensors 200, 204 and 206 include a wire mesh sensor that measures a local gas volume fraction and phase distribution of a flow across a section of the pipeline 192. The sensors 200, 204, 206 may be pressure, temperature, density, conductivity, mass flow, ultrasound, and optical waves, with continuous variable outputs. In another embodiment, the sensors 200, 204, 206 are binary specialized sensors with discrete output like presence/no presence. A mounting distance between the sensors 200, 204, 206, as well as between the sensors and the pump 208 are pre-determined. The distances also depend upon characteristics of the pipelines and type of material flowing through the pipelines. When the sensor 200 detects a slug, a pressure wave oscillation is created to destroy or dilute the slug. The pressure wave distortion is created by controlling torque, speed or power of a pump or compressor 208. In a case of a mild slug, a driving torque in the pump 208 is changed to destroy the slug. The torque is changed via electronics 210 coupled with a control system 212. In a particular embodiment, the electronics 210 is a power converter coupled to an electric motor. The control system 212 performs functions such as anti slug, modulation of torque to obtain a mild slug pass through the pump 208, and to shut off the pump 208 in an emergency situation such as, when a torque above an acceptable limit is required to eliminate the slug. A set of valves 214 and drain lines 216 are installed after sensors 200 and 204. The drain lines 216 coalesce into a mixing point 217, separate of the pipeline 192, and the mixing point 217 is fed back through a tertiary valve 219 to the pipeline 192 at a point after the sensor 206.

When the sensor 200 detects a slug, the control system 212 creates an unsteady flow oscillation upstream that affects the slug traversing slightly after sensor 200. In one embodiment, the unsteady oscillation is sufficient to destroy or dilute the slug, which is detected by the sensor 204. In such a case, the operation is continued as normal. In another embodiment, if the unsteady oscillation does not dilute or destroy the slug, the sensors 200 and 204 are ‘active’, and the third sensor 206 detects the slug. As used herein, the term ‘active’ refers to detection of a slug. In yet another embodiment, the sensors 204 and 206 may be ‘active’, but the sensor 200 may not be ‘active’ implying that the slug is small and may be traversed through the pump 208 with a small enough force or torque such that not to damage the pump. In another exemplary embodiment, when the sensors 200, 204, and 206 remain ‘active’, the slug is considered too large for safe transferal through the pump and a plant shutdown is requested.

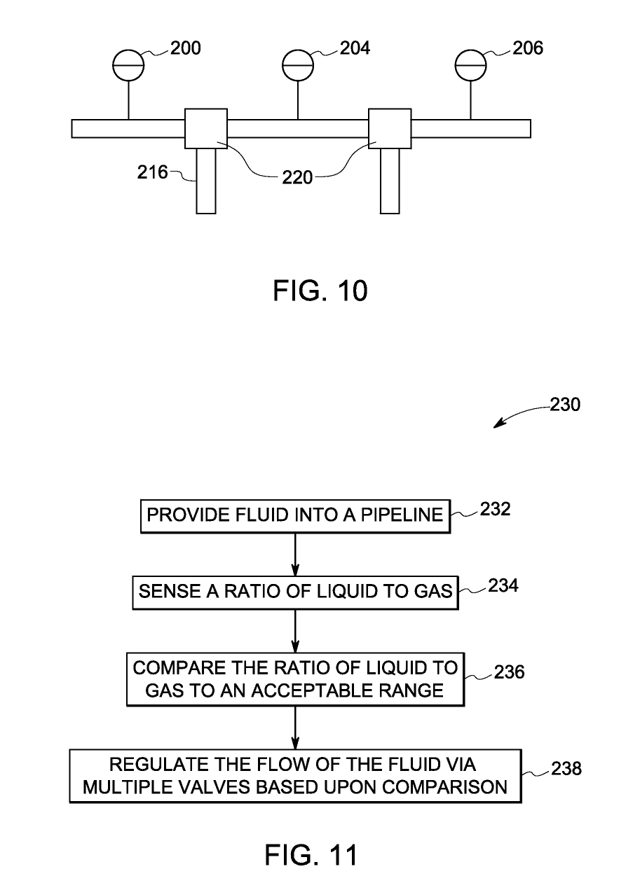

The pipeline 192 is optionally fitted with backward facing elements 220, as illustrated in FIG. 10, inducing a change in diameter of the pipeline. The backward facing elements constrict flow to enable effect of pressure wave initiated at the pump 208 (FIG. 9). Parameters such as volume of the pipeline 192 between the sensors 200, 204 and 206 and the pump 208, and the diameters are critical for determining amount of backward pressure and mass flow waves to be generated at the pump. The parameters sensed upstream are coded and transmitted by electromagnetic means and decoded, amplified and employed in a control algorithm via the control system 212. The control system 212 further generates controlling actions such as, variations in time of pressure and flow inside the pipeline 192. The variations are caused by changes in various parameters such as, but not limited to, delivered electric force, torque, shaft speed, displacement speed, and power of the pump 208.

FIG. 11 is a flow chart representing steps in an exemplary method 230 for stabilizing flow in a pipeline. The method 230 includes providing fluid into a pipeline in step 232. In one embodiment, the fluid is pumped via an internal or an external supply. In another embodiment, liquid and gas in the fluid is separated prior to pumping the fluid via a liquid-gas separator. In yet another embodiment, excess liquid and gas are stored in a storage facility. A ratio of liquid to gas of the flow is sensed in step 234. In a particular embodiment, the ratio is sensed via multiple wire mesh sensors. Further, the ratio is compared to an acceptable range in step 236. The flow of the fluid is regulated via multiple valves based upon comparison in step 238.

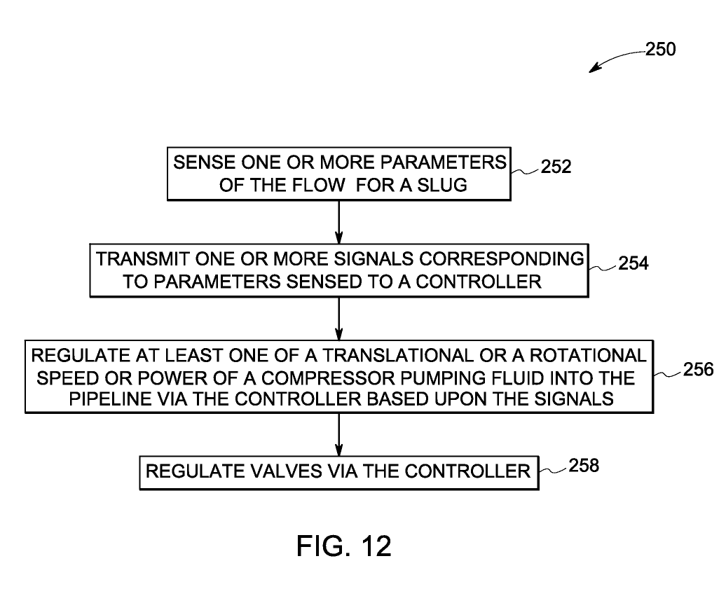

FIG. 12 is a flow chart representing steps in another exemplary method 250 for stabilizing flow in a pipeline. The method 250 includes sensing one or more parameters of the flow for the slug in step 252 via multiple sensors disposed at a multiple locations in the pipeline. Signals corresponding to the parameters sensed are transmitted to a controller in step 254. At least one of a translational or a rotational speed or power of a compressor pumping fluid into the pipeline is regulated in step 256 via the controller based upon the signals and a detection of the slug in order to create an unsteady flow oscillation to affect a flow of the slug. In a particular embodiment, the signals are transmitted from the controller to a variable speed drive system coupled to the compressor, in order to regulate the speed. Motion of multiple valves is further regulated upon detection of the slug in step 258. In one embodiment, the compressor is powered down in case of an emergency. In another embodiment, multiple drains are installed with multiple drain valves to dispose the slug.

The various embodiments of a system and method to eliminate flow instabilities or slugs described above thus provide slug free operation of the pipelines resulting in increased production from a wellhead and reduction of undesirable losses. The ability to detect slug events or slug flow regimes and employ protective measures to mitigate the effect of slug events and/or to alter the flow regime helps to avoid damage to the machinery and enables extended lifetime.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a slug indicator with respect to one embodiment can be adapted for use with recirculation equipment described with respect to another. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for detecting and controlling a slug event in a flow through a pipeline comprising:
a plurality of sensors configured to indicate one or more parameters of the flow for a slug at a plurality of locations in the pipeline;
a controller configured to receive one or more response signals corresponding to at least one of the parameters from the plurality of sensors;
a variable speed drive system electrically coupled to the controller and a compressor pumping fluid in the pipeline such that a ratio of liquid to gas is within an acceptable range, the variable speed drive configured to receive one or more signals from the controller and further configured to regulate at least one of a translational or a rotational speed or a power of the compressor based upon the signals; and
a display unit coupled to the controller, the display unit configured to output the plurality of signals received from the controller.

2. The system of claim 1, wherein the plurality of sensors comprise at least one of a wire mesh sensor or a binary specialized sensor with a discrete output.

3. The system of claim 1, wherein the parameters of the flow comprise at least one of pressure, density, conductivity, temperature, mass flow, ultrasound and optical.

4. The system of claim 1, wherein the plurality of locations comprise a location of at least one of a plurality of dip pipes and a location of at least one of a plurality of riser pipes.

5. The system of claim 1, wherein the variable speed drive system comprises an electric motor.

6. The system of claim 1, wherein the signals to the compressor comprise signals corresponding to a torque of the compressor.

7. The system of claim 1, wherein the plurality of sensors are configured to indicate parameters related to parts involved in operation of the compressor.

8. The system of claim 7, wherein the parameters comprise a rotational or translational speed of a shaft of the compressor.

9. The system of claim 1, wherein the controller is further configured to regulate motion of a plurality of valves in the pipeline.

10. The system of claim 1, wherein the controller, the variable speed drive system and the compressor are electrically coupled via electrical cables.

11. The system of claim 1, wherein the controller, the variable speed drive system and the compressor are electrically coupled via a wireless connection.

12. The system of claim 1, further comprising a plurality of drain pipes and drain valves to dispose the slug.

13. The system of claim 1, wherein the compressor comprises at least one of a pump, a translational or a rotational organ.

14. A method for controlling a slug event in a flow through a pipeline comprising:
sensing one or more parameters of the flow for the slug via a plurality of sensors disposed at a plurality of locations in the pipeline;
transmitting one or more signals corresponding to the parameters sensed to a controller;
regulating at least one of a translational or a rotational speed or power of a compressor pumping fluid into the pipeline via the controller based upon the signals and a detection of the slug in order to create an unsteady flow oscillation to affect a flow of the slug; and
regulating a plurality of valves via the controller upon detection of the slug.

15. The method of claim 14, wherein the regulating comprises transmitting signals from the controller to a variable speed drive system coupled to the compressor.

16. The method of claim 14, further comprising powering down the compressor in an emergency.

17. The method of claim 14, further comprising providing a plurality of drain pipes with a plurality of drain valves to dispose the slug.
